(19) United States
(12) Patent Application Publication
(10) Pub. No.: US 2003/0054098 A1
(43) Pub. Date: Mar. 20, 2003

(54) Apparatus to manufacture a disc and method to form a transparent layer thereof

(75) Inventors: Do-Hoon Chang, Seoul (KR); In-sik Park, Gyeonggi-do (KR); Myong-do Ro, Gyeonggi-do (KR); Du-seop Yoon, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd.

(21) Appl. No.: 10/224,570

(22) Filed: Aug. 21, 2002

(30) Foreign Application Priority Data
Aug. 21, 2001 (KR) 2001-50320

(51) Int. Cl. B05D 3/12; B05D 3/06

(52) U.S. Cl. 427/240; 427/346; 427/558; 118/52

(57) ABSTRACT

An apparatus and method to manufacture a disc include a spindle table, a spin coating portion coating a resin onto a disc substrate mounted on the spindle table, and a resin hardening portion hardening the resin, which is coated onto the disc substrate, where the disc substrate is mounted on the spindle table.

### CROSS REFERENCE TO RELATED APPLICATIONS

This application claims the benefit of Korean Application No. 2001-50320 filed Aug. 21, 2001, in the Korean Patent Office, the disclosure of which is incorporated herein by reference.

### BACKGROUND OF THE INVENTION

1. Field of the Invention

The present invention relates to a method of manufacturing a disc, and more particularly, to an apparatus to form a transparent layer of a disc and method thereof.

2. Description of the Related Art

Methods of increasing a recording density of a disc include a method to reduce a diameter of a spot of a laser beam to record on a disc. The diameter of the spot of the laser beam becomes smaller when a wavelength of the laser beam is short and a numerical aperture (NA) of an objective is large. However, there are limitations to reduce the wavelength of the laser beam or to increase the NA of the objective. Thus, if the NA of the objective is increased and the wavelength of the laser beam is reduced, the diameter of the spot of the laser beam is decreased; but, on the other hand, aberration is greatly increased, thereby deteriorating characteristics of a reproducing signal.

FIG. 1 is a cross-sectional view of a conventional disc. Referring to FIG. 1, the disc includes a disc substrate 10 and a transparent layer 15, and an axial hole 14 is formed at a center of the disc. In the case of a high density digital versatile disc (HD-DVD), a thickness T of the disc substrate 10 is 1.1 mm, and a thickness d of the transparent layer 15 is 0.1 mm, and a total thickness of the disc is 1.2 mm. In particular, in order to precisely focus the laser beam, which is radiated from a reproducing apparatus, on the surface of the transparent layer 15, the thickness of the transparent layer 15 should be within a range of 100 μm±3 μm. A method to form the thin transparent layer 15 includes a spin coating method.

FIG. 2 is a reference view illustrating a method to form the transparent layer according to a conventional spin coating method. In the conventional spin coating method, a liquid ultraviolet hardening resin 13 is dropped at a point on a surface of the disc substrate 10, which rotates at a low speed, and then, the disc substrate 10 is rotated at a high speed, as shown in FIG. 2. The liquid ultraviolet hardening resin 13 is spread throughout the disc substrate 10 in a radial direction by centrifugal force to coat the disc substrate 10. Next, an ultraviolet ray is radiated on the coated ultraviolet hardening resin 13, thereby hardening the ultraviolet hardening resin 13.

When forming the thin transparent layer 15 using the spin coating method, the thickness of the transparent layer 15 depends on processing conditions such as a spinning speed, a spinning time, a dispensing position of the ultraviolet hardening resin 13, and a dispensing amount, and a property of the ultraviolet hardening resin 13 such as viscosity. In particular, in order to coat the transparent layer 15 to the thickness of 100 μm, the viscosity of the ultraviolet hardening resin 13 should be more than several hundreds centi-poise (cps). As the viscosity of the ultraviolet hardening resin 13 increases, a uniformity of the thickness of the transparent layer 15 increases, and simultaneously, molecular attraction increases. Thus, the uniformity of the thickness of the transparent layer 15 is affected by a state of the surface on which the ultraviolet hardening resin 13 is dispensed. One of factors related to the state of the dispensed surface is the dispensing position of the ultraviolet hardening resin 13. Thus, the uniformity of the transparent layer 15 is affected by the dispensing position of the ultraviolet hardening resin 13.

FIG. 3 is a graph illustrating a relationship between the dispensing position of the ultraviolet hardening resin 13 and the uniformity of the thickness of the transparent layer 15. FIG. 3 presents the uniformity of the thickness of the transparent layer 15, which is generated when the ultraviolet hardening resin 13 is dispensed toward an axial hole (center) and at 20 mm, 30 mm, 40 mm, and 45 mm of a radius, respectively, of the disc substrate 10 under conditions of 5000 cps of viscosity of the resin, 5 g of the dispensing amount, and 700 rpm of the spinning speed. As shown from FIG. 3, the thickness of the transparent layer 15 is most uniform when the ultraviolet hardening resin 13 is dispensed toward the center of the disc substrate 10.

However, as mentioned above, in the conventional spin coating method, the ultraviolet hardening resin is dispensed not toward the center of the disc substrate, but at a point of the surface of the disc substrate. In the prior art, the resin is coated onto the disc substrate by the spin coating method, the disc substrate is moved into an ultraviolet hardening machine, and then, the resin is hardened.

### SUMMARY OF THE INVENTION

To solve the above and other problems, it is a first object of the present invention to provide an apparatus to manufacture a disc, in which a central dispensing method to dispense a resin toward a center of a disc substrate to form a transparent layer having higher uniformity can be implemented, and a method to form a transparent layer thereof.

It is a second object of the present invention to provide an apparatus to manufacture a disc, in which wider recording surface can be obtained, and a method to form a transparent layer thereof.

Accordingly, to achieve the above and other objects, according to an aspect of the present invention, there is provided an apparatus for manufacturing a disc. The apparatus includes a spindle table; a spin coating portion coating a resin onto a disc substrate mounted on the spindle table; and a resin hardening portion hardening the resin, which is coated onto the disc substrate, where the disc substrate is mounted on the spindle table.

The spin coating portion includes a spindle motor rotating the spindle table, a dispensing header having a dispensing nozzle to dispense the resin, a support board supporting the dispensing header, and a spin coating controller controlling the spindle motor, the dispensing header, and the support board and dispensing the resin toward a center of the disc substrate.

To achieve the above and other objects according to an embodiment of the present invention, the resin hardening portion includes an ultraviolet irradiating part, a supporting part supporting the ultraviolet irradiating part, and a resin hardening controller controlling the ultraviolet irradiating part and the supporting part.

To achieve the above and other objects according to an embodiment of the present invention, the ultraviolet irradiating part includes a lamp radiating ultraviolet rays, and a mirror reflecting the ultraviolet rays from the lamp onto the disc substrate to harden the ultraviolet hardening resin.

To achieve the above and other objects according to an embodiment of the present invention, the supporting part includes a horizontal support board supporting the ultraviolet irradiating part in a horizontal direction, a vertical support board supporting the horizontal support board, a combining part combining the horizontal support board with the vertical support board so that the horizontal support board and the vertical support board move from side to side with respect to each other, and a motor supplying power to move the horizontal support board or the vertical support board.

To achieve the above and other objects, according to another aspect of the present invention, there is provided a method to form a transparent layer on a disc substrate. The method including: covering an axial hole formed at a center of the disc substrate with a cover element, the disc substrate mounted on a spindle table; dispensing a resin toward an axial hole on a side of the disc substrate; and removing the cover element.

To achieve the above and other objects according to an embodiment of the present invention, further including: rotating the disc substrate at a high speed and uniformly coating the resin onto the disc substrate; and hardening the coated resin.

To achieve the above and other objects according to an embodiment of the present invention, wherein after uniformly coating the resin, the method further including separating the disc substrate from the spindle table to support and rotate the disc substrate.

To achieve the above and other objects according to an embodiment of the present invention, further including hardening the coated resin.

To achieve the above and other objects according to an embodiment of the present invention, wherein prior to covering the axial hole, the method further including: a−0)] inserting a central axis of the spindle motor, which is projected from the spindle table, in the axial hole of the disc substrate and mounting the disc substrate on the spindle table, wherein a sum of a length of the central axis projected from the spindle table and a length of a protrusion is less than a thickness of the disc substrate.

To achieve the above and other objects according to an embodiment of the present invention, wherein the cover element is removed using a magnet or a puncher.

To achieve the above and other objects according to an embodiment of the present invention, it is provided a method to manufacture a disc, including: mounting a disc substrate on a spindle table; covering an axial hole formed at a center of the disc substrate with a cover element; rotating the disc substrate at a first speed; dispensing a predetermined amount of ultraviolet hardening resin toward the center of the disc substrate; rotating the disc substrate at a second speed; and removing the cover element.

To achieve the above and other objects according to an embodiment of the present invention, it is provided a method to manufacture a disc, including: mounting a disc substrate on a spindle table; covering an axial hole formed at a center of the disc substrate with a cover element; rotating the disc substrate at a first speed; dispensing a predetermined amount of ultraviolet hardening resin toward the center of the disc substrate; rotating the disc substrate at a second speed; lifting the spindle table; attaching the ultraviolet irradiating part to the spindle table so that the ultraviolet rays radiated from a lamp do not leak out and to harden the ultraviolet hardening resin; and removing the cover element.

These together with other objects and advantages, which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above objective and advantage of the present invention will become more apparent by describing in detail preferred embodiments thereof with reference to the attached drawings in which:

FIG. 1 is a cross-sectional view of a conventional disc;

FIG. 2 is a reference view illustrating a conventional spin coating method;

FIG. 3 is a graph illustrating a relationship between a dispensing position of a resin and a uniformity of a thickness of a layer;

FIG. 4 is a front view of an apparatus to manufacture a disc according to an embodiment of the present invention;

FIG. 5 is a side view of the apparatus to manufacture the disc according to an embodiment of the present invention;

FIG. 6 is an example of a spin coating portion shown in FIGS. 4 and 5;

FIG. 7 is another example of the spin coating portion shown in FIGS. 4 and 5;

FIG. 8 is a flow chart illustrating a method to manufacture the disc according to a first embodiment of the present invention;

FIG. 9 is a flow chart illustrating a method to manufacture the disc according to a second embodiment of the present invention; and

FIG. 10 is a reference view illustrating a method to remove a cover element.

### DETAILED DESCRIPTION OF THE PREFERRED EMBODIMENTS

Hereinafter, embodiments of the present invention will be described in detail with reference to the attached drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

One of features of an apparatus to manufacture a disc and a method thereof according to an embodiment of the present invention, is that spin coating and resin-hardening are performed in one apparatus such that there is no need to move the disc when manufacturing a transparent layer. In other words, in the apparatus to manufacture the disc, spin coating is performed on the disc, and then, the disc is not moved, and then the coated resin is hardened.

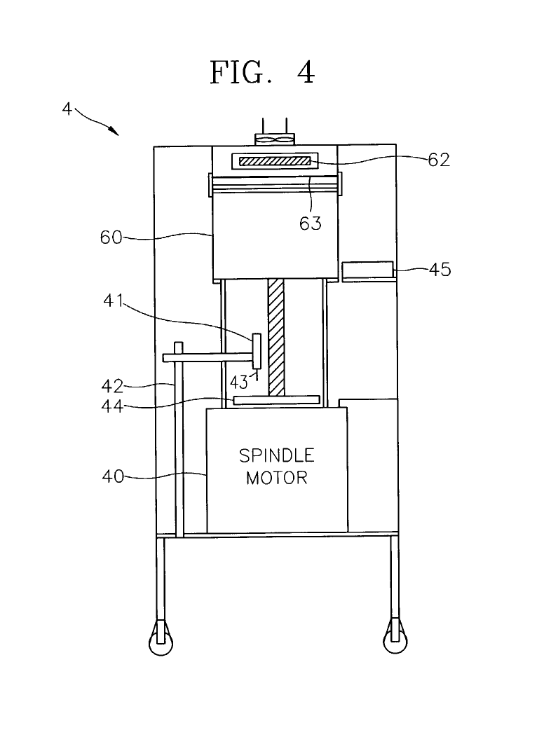

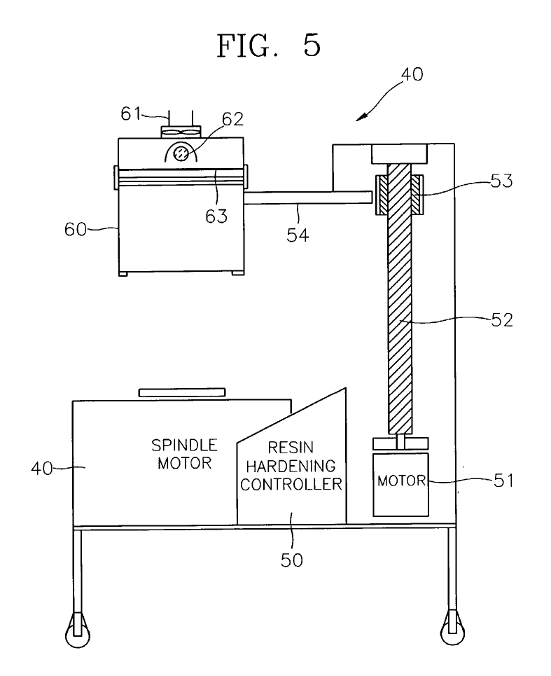

FIG. 4 is a front view of the apparatus 4 to manufacture the disc according to an embodiment of the present invention. FIG. 5 is a side view of the apparatus to manufacture the disc according to an embodiment of the present invention. Referring to FIGS. 4 and 5, the apparatus 4 to manufacture the disc includes a spin coating portion to coat a resin onto a disc substrate and a resin hardening portion to harden the coated resin.

The spin coating portion includes a spindle motor 40 to rotate a spindle table 44 on which the disc substrate is seated, a dispensing header 41 on which a dispensing nozzle 43 to dispense the resin is arranged, a support board 42 to support the dispensing header 41, and a spin coating controller 45.

The resin hardening portion includes an ultraviolet irradiating part 60, a supporting part to support and to move the ultraviolet irradiating part 60, and a resin hardening controller 50 to control the ultraviolet irradiating part 60 and the supporting part. The ultraviolet irradiating part 60 includes a lamp 62 to radiate ultraviolet rays, and a mirror 63 to reflect the ultraviolet rays from the lamp 62. Because the ultraviolet hardening resin is used in the embodiments of the present invention, the ultraviolet hardening resin is implanted by the ultraviolet irradiating part 60, but may be changed accordingly in case that the resin is hardened by another method. The supporting part includes a horizontal support board 54 to support the ultraviolet irradiating part 60 in a horizontal direction, a vertical support board 52 to support the ultraviolet irradiating part 60 in a vertical direction, a combining part 53 to combine the horizontal support board 54 with the vertical support board 52 so that the horizontal support board 54 and the vertical support board 52 may move from side to side with respect to each other, or the horizontal support board 54 moves upward and downward along the vertical support board 52. A motor 51 in the supporting part moves the horizontal support board 54 and the vertical support board 52 in the vertical direction or by rotation. The combining part 53 and the vertical support board 52 may include a combining screw and a screw rod. A groove may be formed in the screw rod so that the combining screw moves upward and downward.

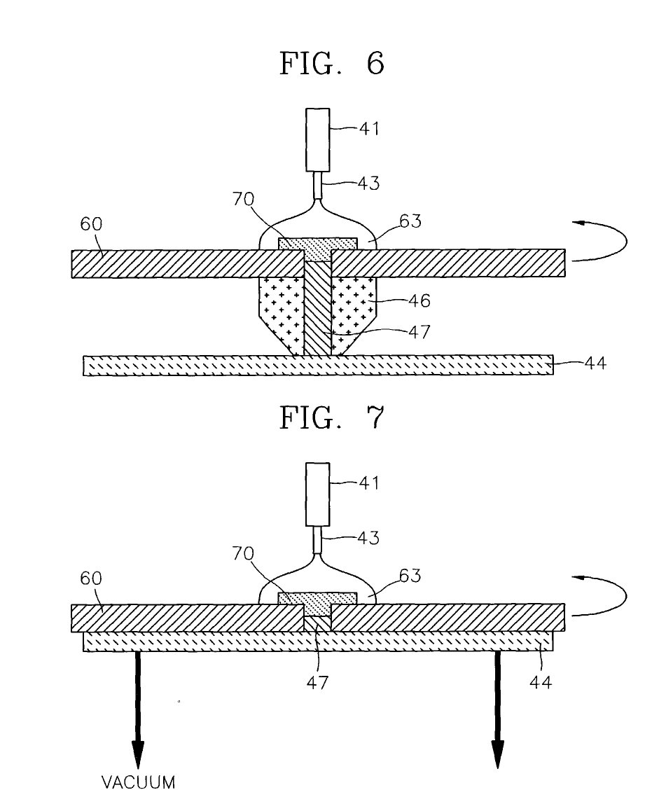

FIG. 6 is an example of the spin coating portion shown in FIGS. 4 and 5. Referring to FIG. 6, in order to realize a central dispensing method to dispense the resin toward an axial hole formed at a center of the disc substrate 60, a rotation support board 46 to surround an central axis 47 of the spindle motor 40 is installed between the spindle table 44 of the spin coating portion and the disc substrate 60, so that the disc substrate 60 is more stably rotated and supported. A material of the rotation support board 46 is nonrestrictive, and plastics and metals can be used for the rotation support board 46.

The central axis 47 of the spindle motor 40 is projected into an external side of the rotation support board 46 so that the central axis 47 of the spindle motor 40 is inserted in the axial hole of the disc substrate 60. A cover element 70 covers the axial hole of the disc substrate 60, thereby preventing the resin from leaking through the axial hole, and a protrusion is formed under the cover element 70, thereby preventing the disc substrate 60 from shaking when the disc substrate 60 rotates at a high speed. In order to easily remove residue of a contaminated resin during rotation, the cover element 70 can be coated with a material minimizing a surface tension of the cover element 70, for example, polytetra fluoride such a tefron. In order to closely attach the disc substrate 60 to the rotation support board 46 and the spindle table 44, a sum of a length u of the protrusion of the cover element 70 and a length p of a portion projected into the external side of the rotation support board 46 of the central axis 47 may be smaller than or equal to a thickness d of the disc substrate 60, which is expressed by Equation 1:

u+p≦d (1)

FIG. 7 is another example of the spin coating portion shown in FIGS. 4 and 5. Referring to FIG. 7, unlike FIG. 6, the rotation support board 46 is not installed, but the disc substrate 60 is mounted directly on the spindle table 44. As in FIG. 6, the cover element 70 is installed on the disc substrate 60. The cover element 70 covers the axial hole of the disc substrate 60, thereby preventing the resin from leaking through the axial hole, and the protrusion is formed under the cover element 70, thereby preventing the disc substrate 60 from shaking when the disc substrate 60 rotates at a high speed. In order to easily remove residue of the contaminated resin during rotation, the cover element 70 can be coated with a material minimizing the surface tension of the cover element 70, for example, Polytetra fluoride such a tefron.

The central axis 47 of the spindle motor 40 is projected into the external side of the spindle table 44 so that the central axis 47 of the spindle motor 40 is inserted in the axial hole of the disc substrate 60. The radius of the spindle table 44 is smaller than that of the disc substrate 60. A protrusion is formed under the cover element 70 in order to prevent the disc substrate 60 from shaking when the disc substrate 60 rotates at a high speed. In order to closely attach and support the disc substrate 60 to the rotation support board 46 and the spindle table 44, the sum of the length u of the protrusion of the cover element 70 and the length p of the portion projected into the external side of the spindle table 44 of the central axis 47 may be smaller than or the same as the thickness d of the disc substrate 60, which is expressed by Equation 2:

u+p≦d (2)

In order to prevent a rear side of the disc substrate 60 from being contaminated due to spatter of the resin during rotation, a sum of the length of the protrusion of the cover element 70 and the length of the projected central axis 47 may be a little smaller than the thickness of the disc substrate 60.

On this basis, a method to manufacture a disc according to preferred embodiments of the present invention will be described below.

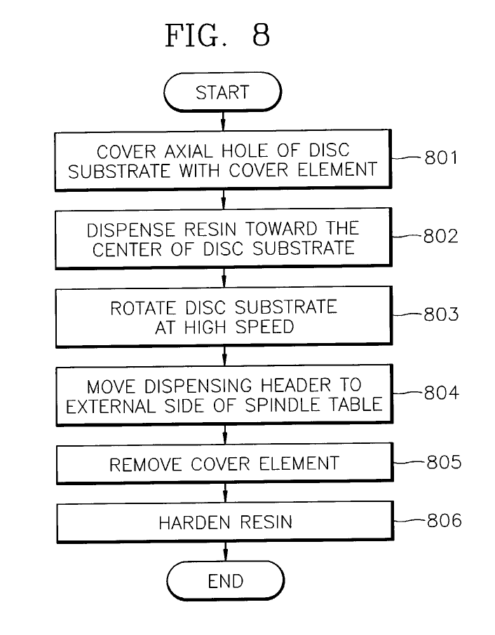

FIG. 8 is a flow chart illustrating a method to manufacture the disc according to a first embodiment of the present invention. Referring to FIG. 8, at operation 801, the disc substrate 60 (FIGS. 6 and 7) is mounted on the spindle table 44 such that the surface of the disc substrate 60 onto which the transparent layer is to be formed faces upward, and then, the axial hole, which is formed at the center of the disc substrate 60, is covered with the cover element 70. At operation 802, the spindle motor 40 is controlled by the spin coating controller 45, the disc substrate 60 is rotated at a low speed, and then, the predetermined amount of the ultraviolet hardening resin is dispensed toward the center of the disc substrate 60 through the dispensing nozzle 43 of the dispensing header 41.

At operation 803, the spindle motor 40 is controlled by the spin coating controller 45, and the disc substrate 60 mounted on the spindle table 44 is rotated at a high speed. At operation 804, the ultraviolet hardening resin is spread out onto the disc substrate 60 in the radial direction by centrifugal force caused by the rotation of the disc to uniformly coat the entire surface of the disc substrate 60. The spin coating controller 45 moves the dispensing header 41 from the upper side of the spindle table 44 to the external side of the spindle table 44. At operation 805, the cover element 70 is removed. If the cover element 70 is made of metal, the cover element 70 is removed using a magnet. At operation 806, the ultraviolet irradiating part 60 (FIGS. 4 and 5) attaches completely and closely to the spindle table 44 by the resin hardening controller 50, so that the ultraviolet rays radiated from the lamp 62 do not leak out, and the ultraviolet rays are radiated through the lamp 62, and then, the ultraviolet hardening resin is hardened.

The lamp 62 may radiate a predetermined amount of ultraviolet rays more than 120 mm. The disc substrate 60 is rotated during hardening so that the ultraviolet hardening resin is uniformly hardened. If the resin is exposed to the ultraviolet rays when the resin is dispensed and the resin is not covered, the resin would harden and a person operating the apparatus, according to an embodiment of the present invention, may be harmed. Thus, the ultraviolet irradiating part 60, according to an embodiment of the present invention, attaches completely and closely to the spindle table 44 so that the ultraviolet rays radiated from the lamp 62 do not leak out, the ultraviolet rays are radiated through the lamp 62, and the ultraviolet rays are completely intercepted using a cover (not shown) when the lamp 62 is not used for hardening. The cover may be located in a lowermost portion of the ultraviolet irradiating part 60.

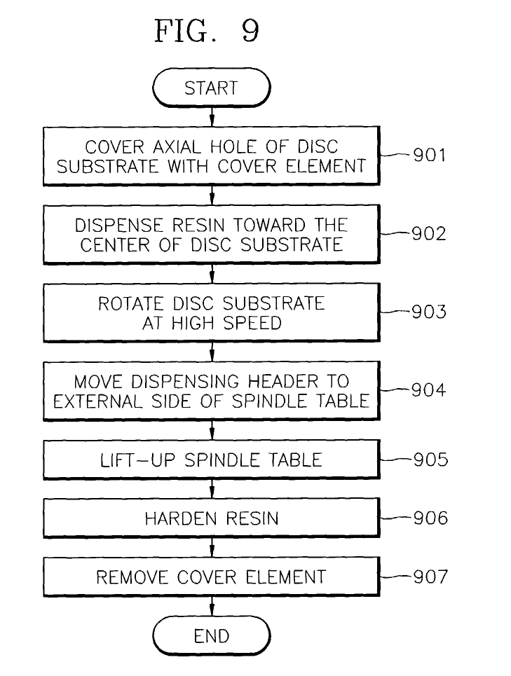

FIG. 9 is a flow chart illustrating a method to manufacture a disc according to a second embodiment of the present invention. Referring to FIG. 9, at operation 901, the disc substrate 60 (FIGS. 6 and 7) is mounted on the spindle table 44 such that the surface of the disc substrate 60 on which the transparent layer is to be formed faces upward, and then, the axial hole, which is formed at the center of the disc substrate 60, is covered with the cover element 70. At operation 902, the spindle motor 40 is controlled by the spin coating controller 45, the disc substrate 60 is rotated at a low speed, and then, a predetermined amount of the ultraviolet hardening resin is dispensed toward the center of the disc substrate 60 through the dispensing nozzle 43 of the dispensing header 41.

At operation 903, the spin coating controller 45 controls the spindle motor 40, and the disc substrate 60 mounted on the spindle table 44 is rotated at a high speed. At operation 904, the ultraviolet hardening resin is spread out the disc substrate 60 in the radial direction by centrifugal force caused by rotation of the disc to uniformly coat the entire surface of the disc substrate 60. The spin coating controller 45 moves the dispensing header 41 from an upper side of the spindle table 44 to the external side of the spindle table 44. At operation 905, the spindle table 44 is slightly lifted-up.

Operations to easily remove the cover element 70 will be now described below. At operation 906, the ultraviolet irradiating part 60 (FIGS. 4 and 5) attaches completely and closely to the spindle table 44 by the resin hardening controller 50 so that the ultraviolet rays radiated from the lamp 62 do not leak out, and the ultraviolet rays are radiated through the lamp 62, and then, the ultraviolet hardening resin is hardened. The lamp 62 may radiate a predetermined amount of the ultraviolet rays more than 120 mm.

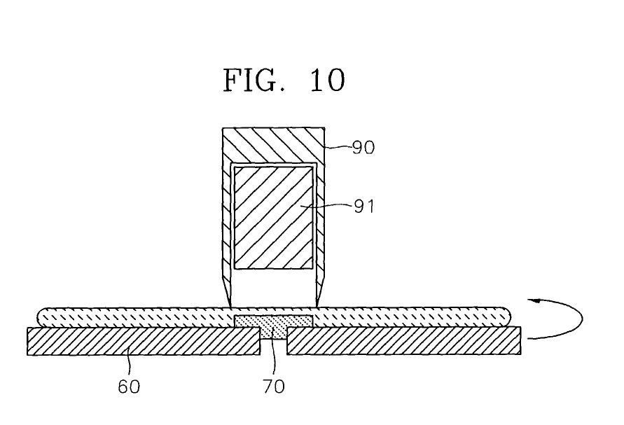

The disc substrate 60 is rotated during hardening so that the ultraviolet hardening resin is uniformly hardened. At operation 907, the cover element 70 is removed. Similarly, if the cover element 70 is made of metal, the cover element 70 may be easily removed using a magnet. The cover element 70 may be also removed using a puncher 90 (FIG. 10). In FIG. 10, if a magnet 91 is buried in an internal side of the puncher 90, the cover element made of metal may be easily removed.

Because the spin coating process and the resin hardening process, according to an embodiment of the present invention, are performed in one apparatus, the disc substrate 60 need not be moved using a vacuum arm, and there is no region to which the vacuum arm is absorbed and adhered. Thus, the central dispensing method, according to an embodiment of the present invention, to dispense the resin toward the center of the disc substrate 60 can be performed. More specifically, in the prior art, the resin is dispensed toward one point (not toward the center) of the disc substrate 60, spin coating is performed, and then, a region (circumference of the axial hole of the disc substrate 60) onto which the resin is not coated is grasped by the vacuum arm and is moved into the hardening machine. A hardening process is then performed. In other words, in the prior art, there is a region in which the vacuum arm is grasped, that is, a region onto which the resin is not coated and which cannot be used as a recording surface.

If the central dispensing method is performed according to the prior art, the liquid resin is coated on the entire region of the disc, and thus, it is difficult to grasp the disc using the vacuum arm. Even though the disc may be moved using another method, the possibility of damage to the transparent layer of the disc is high. However, according to the present invention, the disc substrate 60 need not be moved using the vacuum arm, and thus, the disc can be manufactured without damage to the transparent layer.

Measured values required to form the disc employing the method to manufacture the disc according to an embodiment of the present invention are as follows.

<Conditions for Manufacturing a Disc>

Stamper:

Track pitch in-groove type 0.32 μm

The stamper records tracks at the radius of 22-60 mm to check transfer property.

Injection molding:

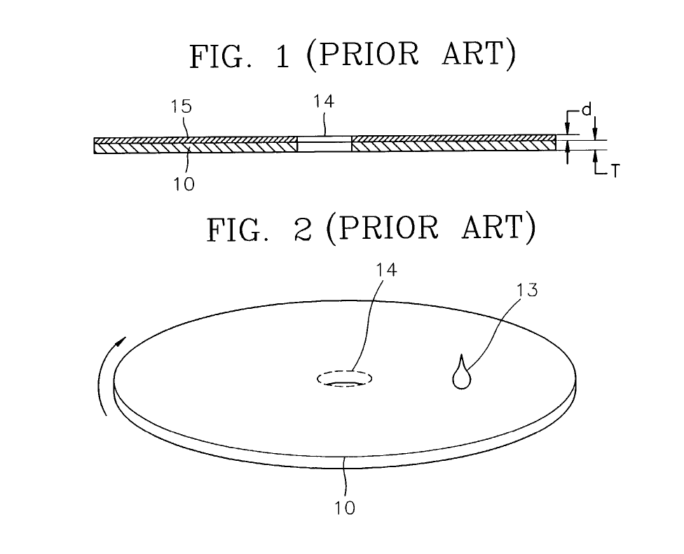

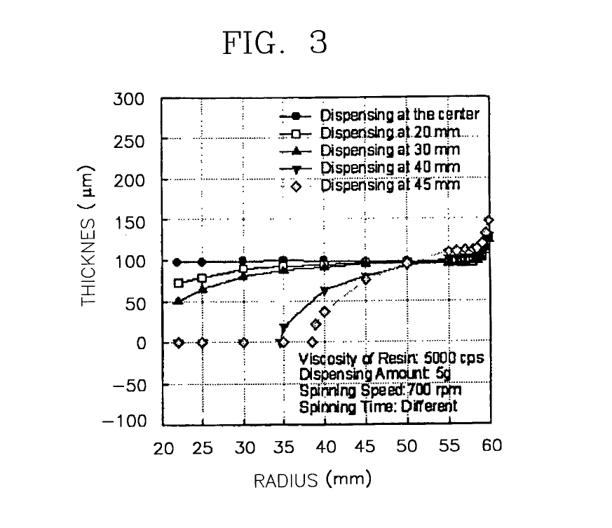

Transfer is good to 58.5 mm of a radius when the disc substrate having 120 mm of a diameter and 1.1 mm of a thickness shown in FIG. 1 is injected.

Condition for injection:

Temperature of fixing mold: 125° C., temperature of moving mold: 125° C.,

Temperature of sprue bush: 90° C., temperature of the resin: maximum 380° C.,

Forces such as 35 ton/sec, 25 ton/sec, and 10 ton/sec, are required to make a form of mold.

Injection molding is performed using the above conditions. As a result of the injection molding, the property of the molding machine is less than 0.3° C., and a streaming flow of the resin is stable to edges of a mask.

Sputtering:

Precision of an external mask: r=59.7 0.2 mm, thickness of edges of the mask (nonuniform region): 0.2 mm,

Four-layer structure: Ag Alloy/ZnSSiO2/SbGeTe/ZnSSiO2

Spin Coating:

The axial hole of the disc substrate is covered by the cover element having 22-44 mm of a diameter and 0.24-0.78 mm of a thickness having various shapes, spin coating is performed on the axial hole on the same conditions, and in most cases, the thickness of 100 μm±2 μm and uniformity are obtained to 17-57 mm of a radius.

Conditions for spin coating:

Viscosity: 500 cps, spinning time: 60-70 sec, spinning speed: 700 rpm,

Hardening time: 3 sec using a lamp of 3000 W

Result of recording and reproducing experiment:

The uniform property is obtained to 17-57 mm of a radius.

As described above, according to the present invention, a uniform transparent layer can be obtained. Further, a spin coating process and a resin hardening process, which are required to form a transparent layer, can be performed in one apparatus without moving a disc substrate, thereby forming a transparent layer by a central dispensing method, and increasing the uniformity of the transparent layer.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. An apparatus to manufacture a disc, the apparatus comprising:
a spindle table;
a spin coating portion coating a resin onto a disc substrate mounted on the spindle table; and
a resin hardening portion hardening the resin, which is coated onto the disc substrate, where the disc substrate is mounted on the spindle table.

2. The apparatus of claim 1, wherein the spin coating portion comprises:
a spindle motor rotating the spindle table,
a dispensing header having a dispensing nozzle to dispense the resin,
a support board supporting the dispensing header, and
a spin coating controller controlling the spindle motor, the dispensing header, and the support board and dispensing the resin toward a center of the disc substrate.

3. The apparatus of claim 1, wherein the resin hardening portion comprises:
an ultraviolet irradiating part,
a supporting part supporting the ultraviolet irradiating part, and
a resin hardening controller controlling the ultraviolet irradiating part and the supporting part.

4. The apparatus of claim 3, wherein the ultraviolet irradiating part comprises:
a lamp radiating ultraviolet rays, and
a mirror reflecting the ultraviolet rays from the lamp onto the disc substrate to harden the ultraviolet hardening resin.

5. The apparatus of claim 4, wherein the supporting part comprises:
a horizontal support board supporting the ultraviolet irradiating part in a horizontal direction,
a vertical support board supporting the horizontal support board,
a combining part combining the horizontal support board with the vertical support board so that the horizontal support board and the vertical support board move from side to side with respect to each other, and
a motor supplying power to move the horizontal support board or the vertical support board.

6. The apparatus of claim 2, wherein the spin coating portion further comprises a rotation support board surrounding a central axis of the spindle motor so that the disc substrate is supported on an upper side of the spindle table.

7. The apparatus of claim 6, wherein the central axis of the spindle motor is projected into an external side of the rotation support board so that the central axis of the spindle motor is inserted in an axial hole of the disc substrate.

8. The apparatus of claim 1, wherein a radius of the spindle table is smaller than a radius of the disc substrate.

9. A method to form a transparent layer on a disc substrate, the method comprising:
covering an axial hole formed at a center of the disc substrate with a cover element, the disc substrate mounted on a spindle table;
dispensing a resin toward an axial hole on a side of the disc substrate; and
removing the cover element.

10. The method of claim 9, further comprising:
rotating the disc substrate at a high speed and uniformly coating the resin onto the disc substrate; and
hardening the coated resin.

11. The method of claim 10, wherein after uniformly coating the resin, the method further comprising separating the disc substrate from the spindle table to support and rotate the disc substrate.

12. The method of claim 9, further comprising hardening the coated resin.

13. The method of claim 12, wherein prior to covering the axial hole, the method further comprising:
inserting a central axis of the spindle motor, which is projected from the spindle table, in the axial hole of the disc substrate and mounting the disc substrate on the spindle table, wherein a sum of a length of the central axis projected from the spindle table and a length of a protrusion is less than a thickness of the disc substrate.

14. The method of claim 9, wherein the cover element is removed using a magnet or a puncher.

15. A method to manufacture a disc, comprising:
mounting a disc substrate on a spindle table;
covering an axial hole formed at a center of the disc substrate with a cover element;
rotating the disc substrate at a first speed;
dispensing a predetermined amount of ultraviolet hardening resin toward the center of the disc substrate;
rotating the disc substrate at a second speed; and
removing the cover element.

16. The method of claim 15, wherein the ultraviolet hardening resin is spread out onto the disc substrate in a radial direction by centrifugal force caused by rotation of the disc to uniformly coat the entire surface of the disc substrate.

17. The method of claim 15, wherein a surface of the disc substrate onto which a transparent layer is to be formed faces upward.

18. The method of claim 15, wherein the cover element is removed using a magnet.

19. The method of claim 15, further comprising:
attaching the ultraviolet irradiating part to the spindle table so that the ultraviolet rays radiated from a lamp do not leak out and the ultraviolet hardening resin is hardened.

20. The method of claim 15, wherein the disc substrate is rotated during hardening so that the ultraviolet hardening resin is uniformly hardened.

21. The method of claim 15, wherein the first speed is a low speed and the second speed is a high speed.

22. A method to manufacture a disc, comprising:
mounting a disc substrate on a spindle table;
covering an axial hole formed at a center of the disc substrate with a cover element;
rotating the disc substrate at a first speed;
dispensing a predetermined amount of ultraviolet hardening resin toward the center of the disc substrate;
rotating the disc substrate at a second speed;
lifting the spindle table;
attaching the ultraviolet irradiating part to the spindle table so that the ultraviolet rays radiated from a lamp do not leak out and to harden the ultraviolet hardening resin; and
removing the cover element.

23. The method of claim 22, wherein the ultraviolet hardening resin is spread out onto the disc substrate in a radial direction by centrifugal force caused by rotation of the disc to uniformly coat the entire surface of the disc substrate.

24. The method of claim 22, wherein a surface of the disc substrate onto which a transparent layer is to be formed faces upward.

25. The method of claim 22, wherein the disc substrate is rotated so that the ultraviolet hardening resin is uniformly hardened.

26. The method of claim 22, wherein the cover element is removed using at least one of a magnet and a puncher, where a magnet is buried in an internal side of the puncher.

27. The method of claim 22, wherein the first speed is a low speed and the second speed is a high speed.
